(19) United States
(12) Patent Application Publication
(10) Pub. No.: US 2012/0143731 A1
(43) Pub. Date: Jun. 7, 2012

(54) APPARATUS AND METHOD FOR TRADING DIGITAL CONTENTS IN DIGITAL CONTENTS MANAGEMENT SYSTEM

(75) Inventors: Jae-Woo Ko, Uiwang-si (KR); Jin-He Jung, Suwon-si (KR); Sung-Yoon Song, Seoul (KR)

(73) Assignee: SAMSUNG ELECTRONICS CO., LTD., Suwon-si (KR)

(21) Appl. No.: 13/312,346

(22) Filed: Dec. 6, 2011

(30) Foreign Application Priority Data
Dec. 6, 2010 (KR) 10-2010-0123232
Jan. 10, 2011 (KR) 10-2011-0002161

(51) Int. Cl. G06Q 30/06

(52) U.S. Cl. 705/27.1

(57) ABSTRACT

An apparatus and a method transact digital contents. More particularly, an apparatus and a method for inserting a purchaser's signature into digital contents and providing the same in a digital contents management system are provided. The apparatus includes a purchaser terminal, a contents server, and a receiver terminal. The purchaser terminal detects a user's input, writes a signature to be inserted into contents, and transmits the written signature to a contents server when purchasing contents. The contents server inserts the signature received from the purchaser terminal into original digital contents. The receiver terminal receives and reproduces the original digital contents to which the signature has been added.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Dec. 6, 2010 and assigned Serial No. 10-2010-0123232 and Korean patent application filed in a Korean Intellectual Property Office on Jan. 10, 2011 and assigned Serial No. 10-2011-0002161, the entire disclosure of both of which are hereby incorporated by reference.

### TECHNICAL FIELD OF THE INVENTION

The present invention relates to an apparatus and a method for transacting digital contents. More particularly, the present invention relates to an apparatus and a method for inserting a purchaser's signature into digital contents and providing the same in a digital contents management system.

### BACKGROUND OF THE INVENTION

Recently, with rapid development of a computer, the Internet, storage media, etc., digital contents where various documents and contents have been produced in the form of computer-readable digital data are distributed.

Unlike analog contents, the digital contents maintain the same quality as the original contents even after several times of duplications, and may include a digitalized electronic ticket, moving image data, media data, electronic book data, etc.

Unlike an off-line purchase method where a user visits a store in person to purchase contents, an on-line purchase method provides an advantage of allowing a user to purchase digital contents on-line at home, so that an interest in digital contents increases recently.

FIG. 1 is a view illustrating a purchase procedure of a general digital contents management system.

Referring to FIG. 1, the digital contents management system may include a contents server 100, a purchaser 102, and a receiver 104. It is assumed that the purchaser 102 purchases digital contents and presents the digital contents to the receiver 104.

First, the contents server 100 stores (110) sellable Digital Rights Management (DRM) contents, and when receiving the purchaser's request 112 for purchasing the stored contents, the contents server 100 provides (114) a list of sellable contents to the purchaser 102.

Accordingly, the purchaser 102 may recognize the list and select desired contents, and provides (116) the selected purchase contents item to the contents server 100.

After that, the purchaser 102 performs (118) a payment procedure for the contents to be purchased, and provides information of the receiver 104 (a user to which the purchaser desires to present the purchased contents) who receives the purchased contents to the contents server 100.

When the payment procedure is completed, the contents server 100 provides (120) the contents purchased by the purchaser 102 to the receiver 104, and the receiver 104 who has received the contents reproduces (122) the received contents.

In the off-line contents purchase, a purchaser may purchase a CD, a DVD, a book, etc. and then add a signature to present the same. In the current on-line digital contents purchase, a copyright is limited depending on a Digital Rights Management (DRM) policy of a seller who provides relevant contents and so a signature delivering emotion to purchased contents cannot be added. Accordingly, a receiver who is presented the contents cannot recognize the meaning with which a purchaser has presented the contents.

Therefore, to solve the above problem, an apparatus and a method for adding a purchaser's signature to digital contents are required.

### SUMMARY OF THE INVENTION

To address the above-discussed deficiencies of the prior art, it is a primary object to provide at least the advantages described below. Accordingly, an aspect of the present disclosure is to provide a digital contents management system for inserting a purchaser's signature to digital contents.

Another aspect of the present disclosure is to provide an apparatus and a method for inserting a signature received from a purchaser into original digital contents in a contents server.

Still another aspect of the present disclosure is to provide an apparatus and a method for generating digital contents into which a purchaser's signature has been inserted as DRM contents in a contents server.

Yet another aspect of the present disclosure is to provide an apparatus and a method for receiving a purchaser's signature and providing the same to a contents server in a purchaser's mobile terminal.

In accordance with an aspect of the present disclosure, a contents transaction apparatus of a digital contents management system is provided. The apparatus includes a purchaser terminal for detecting a user's input, writing a signature to be inserted into contents, and transmitting the written signature to a contents server when purchasing contents, the contents server for inserting the signature received from the purchaser terminal into original digital contents, and a receiver terminal for receiving the original digital contents to which the signature has been added and reproducing the same.

In accordance with another aspect of the present disclosure, a contents transaction method of a digital contents management system is provided. The method includes detecting a user's input, writing a signature to be inserted into contents, and transmitting the written signature to a contents server when purchasing the contents, inserting the signature received from the purchaser terminal into original digital contents, and receiving and reproducing the original digital contents to which the signature has been added.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a view illustrating a purchase procedure of a general digital contents management system;

FIG. 2 illustrates a digital contents management system for providing signature inserted-contents according to an exemplary embodiment of the present disclosure;

FIG. 3 illustrates a procedure for adding a purchaser's signature to digital contents in a digital contents server according to an exemplary embodiment of the present disclosure;

FIG. 4 illustrates a procedure for allowing a purchaser who purchases contents to insert a signature into the contents according to an exemplary embodiment of the present disclosure;

FIG. 5 illustrates a procedure for writing a signature to be inserted into contents in a mobile terminal according to an exemplary embodiment of the present disclosure;

FIG. 6 illustrates a screen that executes contents into which a signature has been inserted according to an exemplary embodiment of the present disclosure;

FIG. 7 illustrates a procedure for receiving streaming contents into which a signature has been inserted in a mobile terminal according to an exemplary embodiment of the present disclosure;

FIG. 8A illustrates a procedure for reproducing streaming contents in the conventional mobile terminal; and

FIG. 8B illustrates a procedure for reproducing streaming contents in a mobile terminal according to an exemplary embodiment of the present disclosure.

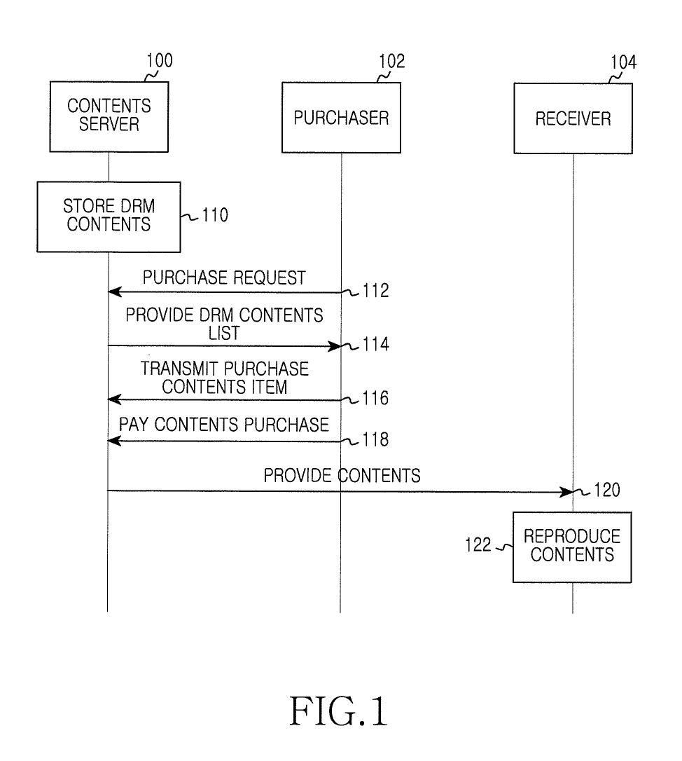

Throughout the drawings, like reference numerals will be understood to refer to like parts, components and structures.

### DETAILED DESCRIPTION OF THE INVENTION

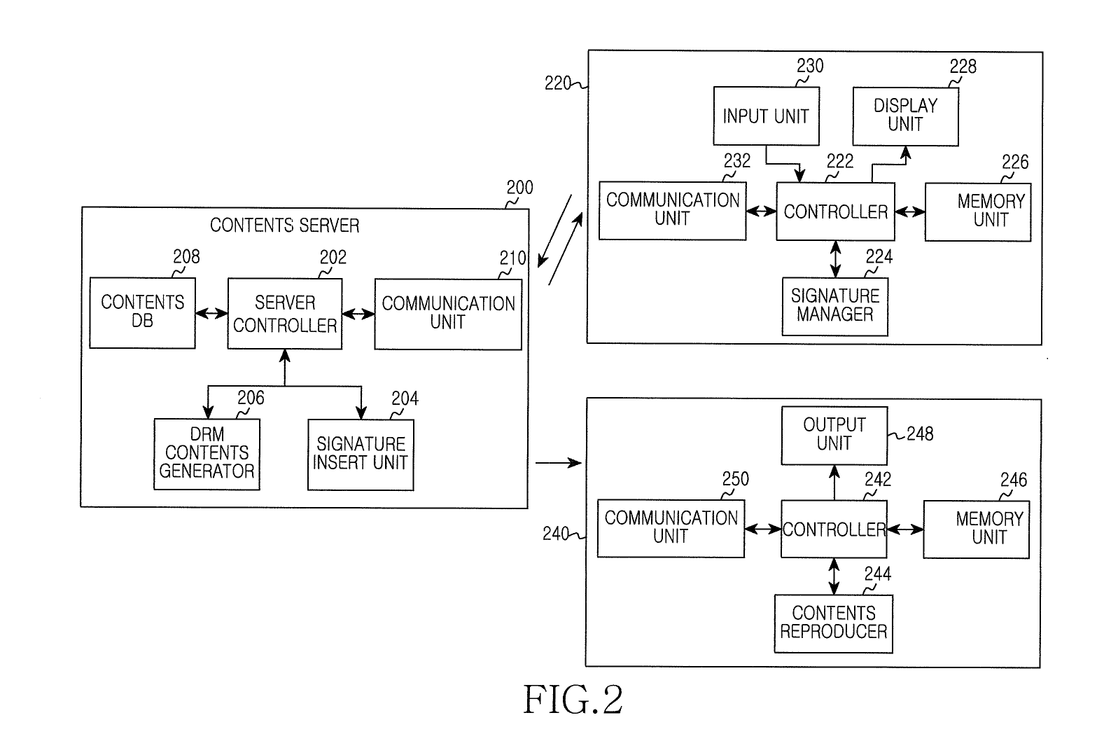

FIGS. 2 through 8B, discussed below, and the various embodiments used to describe the principles of the present disclosure in this patent document are by way of illustration only and should not be construed in any way to limit the scope of the disclosure.

Exemplary embodiments of the present disclosure provide a digital contents management system for inserting a signature received from a purchaser into original digital contents and providing the same in a contents server. In the following description, the purchaser's signature may be a multimedia file including the purchaser's greeting message such as a moving image file, an image file, and an audio file besides a text type signature.

FIG. 2 illustrates a digital contents management system for providing signature inserted-contents according to an exemplary embodiment of the present disclosure.

Referring to FIG. 2, the digital contents management system may include a contents server 200, a mobile terminal 220 who purchases contents, and a mobile terminal 240 who receives purchased contents.

First, the contents server 200 may include a server controller 202, a signature insert unit 204, a DRM contents generator 206, a contents database (DB) 208, and a communication unit 210.

The server controller 202 of the contents server 200 controls an overall operation of the contents server 200. For example, the server controller 202 communicates with the purchaser's terminal 220 to transact stored contents. In addition to the general function, according to an exemplary embodiment of the present disclosure, the server controller 202 inserts the purchaser's signature into contents to be sold according to the purchaser's request. At this point, the server controller 202 inserts the signature into contents to be sold among original digital contents, and then generates the signature inserted-contents as DRM contents to provide the same to the purchaser or a specific receiver designated by the purchaser.

The signature insert unit 204 of the contents server 200 processes to insert the signature provided from the purchaser into original digital contents under control of the server controller 202. At this point, the contents insert unit 204 determines original digital contents which the purchaser desires to purchase to determine a signature insertable region, and then provides the determined region to the purchaser. At this point, the signature insertable region denotes a blank space to which the purchaser's signature may be added among contents forming the original digital contents. In an example of electronic book contents, a table of contents and a summary page where a blank page or a blank space is large may serve as the signature insertable region. In addition, in an example of a digital music file, for example, the signature insertable region may be a cover of a music album.

The DRM contents generator 206 of the contents server 200 generates the original digital contents into which the signature has been inserted by the signature insert unit 204 as DRM contents that gives a use right by purchase and protects a copyright of digital contents.

The contents DB 208 of the contents server 200 stores original digital contents to which a signature may be added.

In addition, the contents server 200 may be a streaming server providing streaming contents. In this example, the contents server 200 may insert a purchaser's signature into streaming contents and provide the same to a receiver. At this point, the contents server 200 may add the purchaser's signature to a frame including a space into which a signature may be inserted, and provide an authentication number to the receiver so that the contents including the signature may be output to only a specific user.

Accordingly, the server controller 202 of the contents server 200 processes to set access limitation to a signature included in the purchased contents (contents including streaming contents). At this point, the server controller 202 may process to add signature insert information (specific figure, a highlight function) to a frame into which a signature has been inserted among frames of the purchased contents or a portion of the frame into which the signature has been inserted, and output the inserted signature via an authentication process when a user who reproduces the contents selects the signature insert information.

The mobile terminal 220 of the purchaser denotes a mobile terminal that can communicate with the contents server such as a computer, a mobile communication terminal, a smart phone, etc. The mobile terminal 220 may include a controller 222, a signature manager 224, a memory unit 226, a display unit 228, an input unit 230, and a communication unit 232.

The controller 222 controls an overall operation of the mobile terminal 220. For example, in the example where the mobile terminal is a mobile communication terminal, the controller 222 performs a process and a control for voice communication and data communication. In addition to the general functions, according to an exemplary embodiment of the present disclosure, the controller 222 processes to receive a signature to be inserted into desired contents and provide the same to the contents server 200.

The signature manager 224 writes a signature to be inserted into purchased contents (contents including streaming contents) under control of the controller 222. The signature manager 224 may write a text type signature input by a user, and a multimedia file such as a moving image file, an image file, and an audio file including a purchaser's greeting message as the purchaser's signature. In addition, the signature manager 224 may provide a signature insert region provided from the contents server 200 to the user, or determine contents information opened by the contents server 200 to directly provide a region (open region on the server) into which a signature is to be inserted to the user.

The memory unit 226 includes Read Only Memory (ROM), Random Access Memory (RAM), and a flash ROM. The ROM stores microcodes of programs for processes and controls of the controller 222 and the signature manager 224, and various reference data.

The RAM serves as a working memory of the controller 222 and stores temporary data that occur during execution of various programs. In addition, the flash ROM stores various updatable data for storage such as a phonebook, calling messages, received messages, meta data, and a database for date storage.

The display unit 228 displays state information occurring during an operation of the mobile terminal, characters, a large amount of moving images and still images, etc. The display unit 228 may be a color Liquid Crystal Display (LCD), an AMOLED, etc. The display unit 228 may include a touch input device, and when it is applied to a touch input type mobile terminal, it can be used as an input unit. In addition, according to an exemplary embodiment of the present disclosure, the display unit 228 outputs an input window for receiving a signature by a user.

The input unit 230 includes a plurality of function keys such as numerical key buttons of 0 to 9, a menu button, a cancel button, an OK button, a TALK button, an END button, an Internet access button, navigation key buttons (or directional keys), letter input keys, etc., and provides key input data corresponding to a key pressed by the user to the controller 222. Accordingly, the user of the mobile terminal 220 may write a signature to be inserted into contents which the user desires to purchase via the input unit 230.

The communication unit 232 transmits/receives a Radio Frequency (RF) signal of data input/output via an antenna (not shown). For example, during transmission, the communication unit 232 channel-codes and spreads data to be transmitted, and then performs an RF process on the signal to transmit the signal. During reception, the communication unit 232 converts a received RF signal into a baseband signal, and despreads and channel-decodes the baseband signal to recover data. The communication unit 232 receives information regarding a region into which a signature can be inserted from the contents server 200, and transmits the written signature to the contents server 200.

At this point, the purchaser's mobile terminal 220 may provide an authentication number to a receiver who receives the purchased contents so that the contents including the signature may be output to only a specific user.

The mobile terminal 240 of the receiver who receives the purchased contents denotes a mobile terminal that can communicate with the contents server such as a computer, a mobile communication terminal, a smart phone, etc. The mobile terminal 240 may include a controller 242, a contents reproducer 244, a memory unit 246, an output unit 248, and a communication unit 250.

The controller 242 controls an overall operation of the mobile terminal 240. For example, in the example where the mobile terminal is a mobile communication terminal, the controller 242 performs a process and a control for voice communication and data communication. In addition to the general functions, according to an exemplary embodiment of the present disclosure, the controller 242 releases a DRM of contents received from the contents server 200 to reproduce contents into which a signature has been inserted. At this point, in an example where reproducing contents (contents including streaming contents) to which an access limitation has been set, the controller 242 processes to perform an authentication process for outputting an inserted signature.

That is, in an example where reproducing a frame of contents to which signature insert information (highlight function or a specific figure) has been set, the controller 242 detects that an access limitation-set signature has been inserted, and processes to reproduce contents without outputting the inserted signature. After that, when detecting a user's input (input of a position to which a highlight function has been set, selection of a specific figure) requesting an output of the inserted signature, the controller 242 performs the authentication process and processes to output the signature to which the access limitation has been set only if the authentication process is performed successfully.

The contents reproducer 244 reproduces contents received from the 7 contents server 200 under control of the controller 242. The contents reproducer 244 releases a DRM of DRM contents to reproduce the contents via the output unit 248.

The memory unit 246 stores microcodes of programs for processes and controls of the contents reproducer 244 and various reference data. According to an exemplary embodiment of the present disclosure, the memory unit 246 receives and stores contents data into which a signature has been inserted.

The output unit 248 outputs contents reproduced by the contents reproducer 244 and includes a display unit for outputting visual contents and a speaker for outputting auditory contents.

The communication unit 250 transmits/receives a Radio Frequency (RF) signal of data input/output via an antenna (not shown). The communication unit 250 receives DRM contents into which a signature has been inserted from the contents server 200.

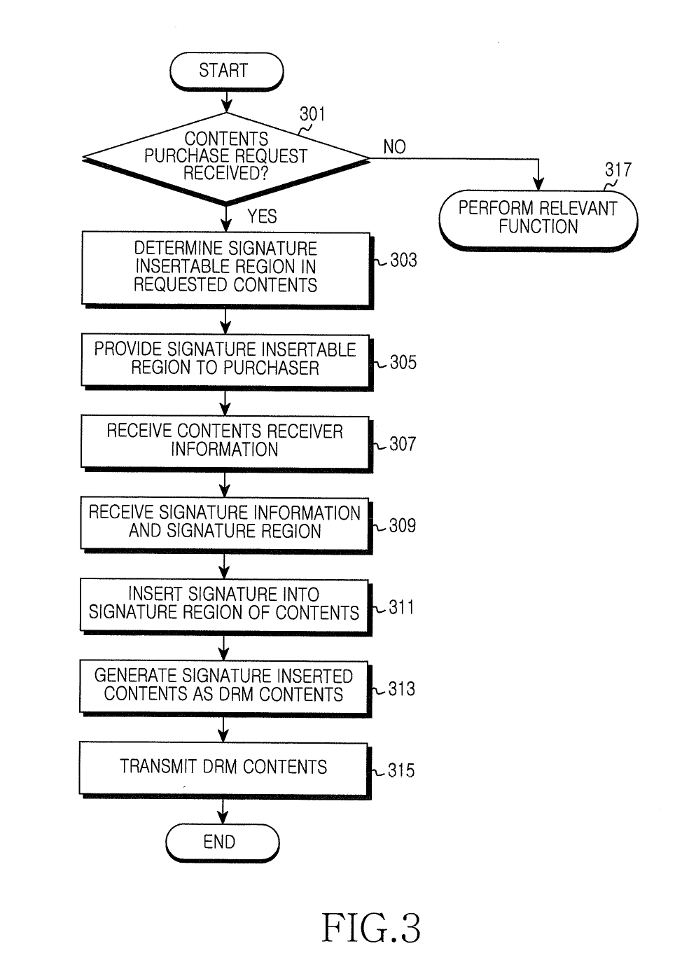

FIG. 3 illustrates a procedure for adding a purchaser's signature to digital contents in a digital contents server according to an exemplary embodiment of the present disclosure.

Referring to FIG. 3, the digital contents server determines whether a contents purchase request is received from a contents purchaser in step 301.

When the contents purchase request is not received in step 301, the digital contents server proceeds to step 317 to perform a relevant function (for example: an idle mode).

In contrast, when the contents purchase request is received in step 301, the digital contents server proceeds to step 303 to determine a region where a signature can be added in the region existing in requested contents. Here, the digital contents server may determine a construction where contents are not included (page where much blank space exist such as a blank page or summary, a table of contents, an album jacket, etc.) as a region to which a signature can be added among a construction of contents which the purchaser desires to purchase.

The digital contents server proceeds to step 305 to transmit the determined region to which the signature can be added to the purchaser, and then proceeds to step 307 to receive information of a receiver who receives the purchase-requested contents.

The digital contents server proceeds to step 309 to receive signature information to be added to contents and a signature region from the purchaser. Here, the signature to be added to the contents may be a multimedia file including the purchaser's greeting word such as a moving image file, an image file, and an audio file besides a text type signature.

The digital contents server proceeds to step 311 to insert a signature written by the purchaser into the signature insert region of the contents, and then proceeds to step 313 to give a use right of the signature-inserted contents, thereby generating DRM contents that protect a copyright of digital contents.

The digital contents server proceeds to step 315 to transmit the generated DRM contents to a receiver designated by the purchaser, and then ends the present algorithm.

Though the contents server determines a region into which a signature is inserted and provides the region to a purchaser in FIG. 3, the purchaser may determine open contents information such as a cover of contents and select in person a region (region on the open cover) into which a signature is to be inserted.

In addition, when requested by the purchaser to set an access limitation for an inserted signature, the contents server adds signature insert information (specific figure, a highlight function) to a frame into which a signature has been inserted or a portion of the frame into which the signature has been inserted, and informs a user who reproduces the contents of existence of the signature to which access limitation has been set. After that, the contents server provides authentication information corresponding to the signature to which the access limitation has been set to a receiver to allow the user (receiver) to perform an authentication process for the signature to which the access limitation has been set using the authentication information afterward.

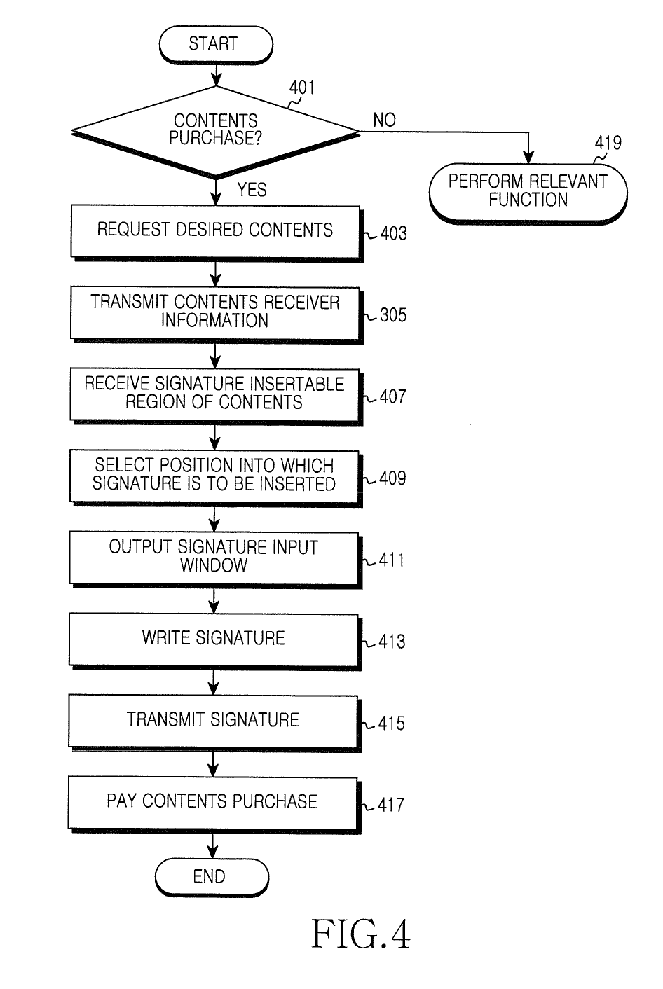

FIG. 4 illustrates a procedure for allowing a purchaser who purchases contents to insert a signature into the contents according to an exemplary embodiment of the present disclosure.

Referring to FIG. 4, the purchaser denotes a user who uses a mobile terminal that can communicate with a contents server, such as a computer, a mobile communication terminal, a smart phone, etc. In the following description, a subject that inserts a signature is defined as a mobile terminal.

The mobile terminal determines whether a contents purchase request by the user is detected in step 401.

When not detecting the contents purchase request in step 401, the mobile terminal proceeds to step 419 to perform a relevant function (for example: idle mode).

In contrast, when detecting the contents purchase request in step 401, the mobile terminal proceeds to step 403 to request a contents server to transmit desired contents and proceeds to step 405 to transmit information of a receiver (for example: a receiver whom the user of the mobile terminal desires to present the purchased contents) of the contents to be purchased to the contents server.

The mobile terminal proceeds to step 407 to receive information regarding a region into which a signature can be inserted from the contents server, and proceeds to step 409 to determine the user's selection and select a position into which a signature is to be inserted.

The mobile terminal proceeds to step 411 to output an input window for receiving a signature from the user, and proceeds to step 413 to write a signature using the user's input. Here, the user's input may be a touch pen input, a voice input, a character input, multimedia file selection, etc. The signature may be a signature via a touch pen input, a text file, and a multimedia file including an audio file and a moving image file.

The mobile terminal proceeds to step 415 to transmit the written signature to the contents server, and then proceeds to step 417 to perform a payment procedure regarding contents to be purchased.

The contents receiver information transmitted in step 405 may be the mobile terminal itself or a different terminal which the user desires to present the contents. Accordingly, the terminal that receives the contents paid in step 417 receives and reproduces DRM contents into which a signature has been inserted. Therefore, the user who receives the contents recognizes the purchaser's signature.

After that, the mobile terminal ends the present algorithm.

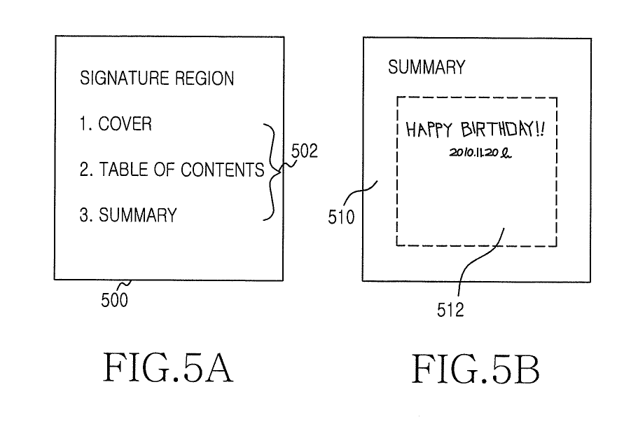

FIG. 5 illustrates a procedure for writing a signature to be inserted into contents in a mobile terminal according to an exemplary embodiment of the present disclosure.

Referring to FIG. 5, the mobile terminal requests a contents server to transmit desired contents when purchasing contents.

Therefore, according to an exemplary embodiment of the present disclosure, the contents server determines whether a region into which a signature can be inserted exists in the desired contents and transmits the region to the purchaser.

The region into which the signature can be inserted denotes a space into which the purchaser's signature can be inserted. In an example of an electronic book, the region into which the signature can be inserted may be a region where much blank space exist such as a blank page or a table of contents, a summary part. In addition, in an example of a digital music file, the region into which the signature can be inserted may be a cover of a music album.

Therefore, the mobile terminal outputs (500) information 502 regarding the region into which the signature can be inserted to allow a user to select a region into which the signature is to be inserted.

When the user selects a summary part as a signature insert region while a signature region 502 representing that a signature can be inserted into a cover, a table of contents, the summary part is output (500) as in FIG. 5A, the mobile terminal outputs (510) an input window 512 for receiving the user's signature as in FIG. 5B, and then receives the user's signature.

For example, in the example where the user (purchaser) transmits electronic book contents as a birthday present, the user may write a signature of “Happy birthday!! 2010.11.20” to be added to the summary part as illustrated.

Accordingly, the contents server inserts the above signature into the contents and then generates DRM contents to transmit the same to a receiver.

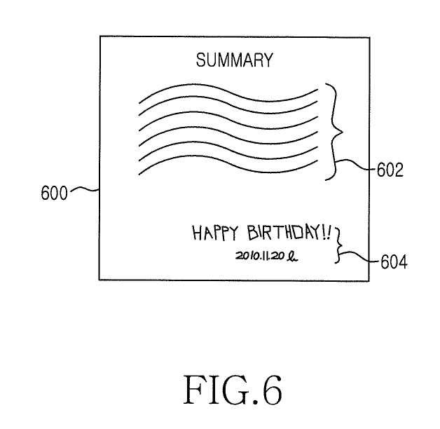

FIG. 6 illustrates a screen that executes contents into which a signature has been inserted according to an exemplary embodiment of the present disclosure.

Referring to FIG. 6, a mobile terminal that has received the contents into which the signature has been inserted detects that the received contents are DRM contents and releases the DRM by deciphering the code.

After that, the mobile terminal executes the DRM-released contents. At this point, a purchaser's signature has been added to the executed contents.

That is, in an example of executing electronic book contents and determining a summary part, the mobile terminal outputs (600) contents including original contents 602 corresponding to the summary and a signature (604) written by a purchaser.

At this point, in the example where the signature added to the electronic book contents is a signature to which an access limitation has been set, the mobile terminal outputs signature insert information (highlight function or a specific figure) informing that the original contents 602 corresponding to the summary and the signature 604 written by the purchaser are included. At this point, the actually inserted signature is not output.

After that, when detecting that the signature insert information is selected by a user, the mobile terminal performs an authentication process for outputting the inserted signature. The mobile terminal processes to output the actually inserted signature only if it successfully performs the authentication process using authentication information received from a contents server or the purchaser.

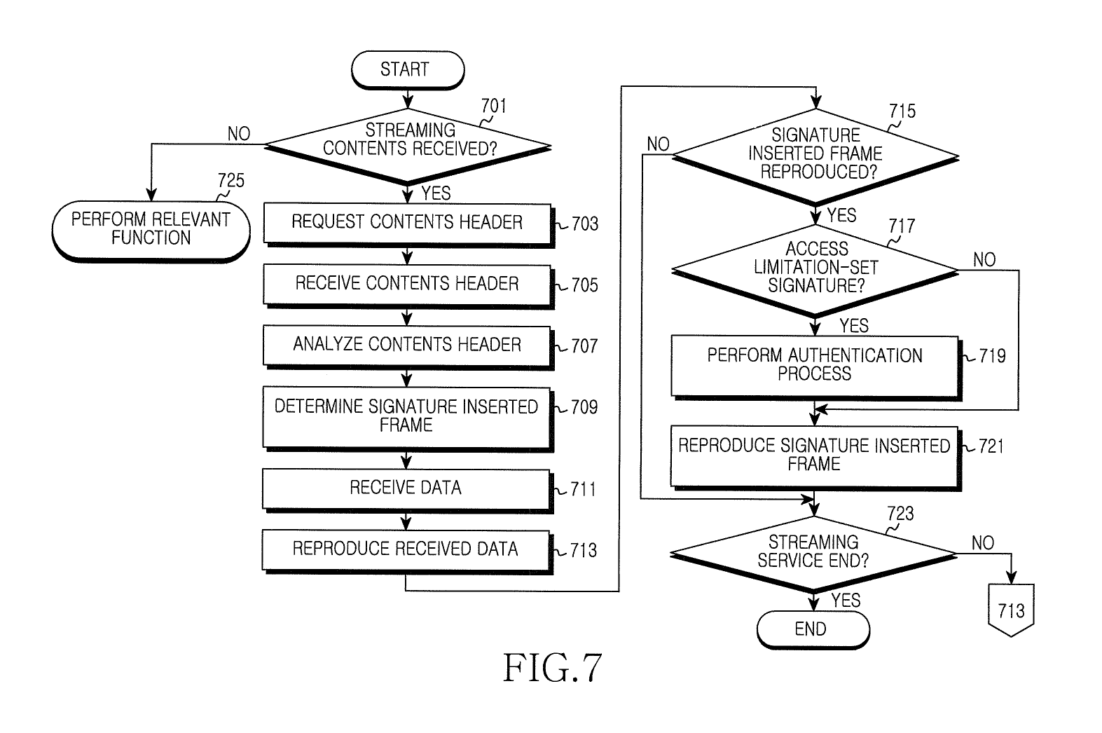

FIG. 7 illustrates a procedure for receiving streaming contents into which a signature has been inserted in a mobile terminal according to an exemplary embodiment of the present disclosure.

Referring to FIG. 7, the mobile terminal determines whether streaming contents are received in step 701.

When determining that the streaming contents are not received in step 701, the mobile terminal proceeds to step 725 to perform a relevant function (for example: idle mode).

In contrast, when determining that the streaming contents are received in step 701, the mobile terminal proceeds to step 703 to request a server that provides a streaming service to transmit a contents header of contents to be provided. Here, the server that provides the streaming service stores a plurality of data to be provided as a streaming service, and may be a multimedia terminal supporting a network function. Furthermore, like the above-described digital contents server, the streaming server may insert a contents purchaser's signature into the streaming contents and provide the same to a receiver. At this point, the streaming server may add the purchaser's signature to a frame including a space into which a signature can be inserted. An operation for signature insertion is similar to that of the digital contents server.

The mobile terminal proceeds to step 705 to receive a contents header from the server. The header received from the server is header information including track information of data which the mobile terminal desires to receive, and includes information regarding a track start position of each audio data and video data and a data type. According to an exemplary embodiment of the present disclosure, the header includes information regarding a track and a frame into which a signature has been inserted.

The mobile terminal proceeds to step 707 to analyze a header received from the server and then proceeds to step 709 to determine the track and the frame into which the signature has been inserted.

The mobile terminal proceeds to step 711 to receive data from the server and store the data in a buffer for a streaming service, and then proceeds to step 713 to reproduce the stored data of a predetermined amount or more.

The mobile terminal proceeds to step 715 to determine whether a reproduction time of data including the signature-inserted frame arrives.

When determining that the reproduction time of data including the signature-inserted frame does not arrive in step 715, the mobile terminal proceeds to step 723 to determine whether to end the streaming service.

In contrast, when determining that the reproduction time of data including the signature-inserted frame arrives in step 715, the mobile terminal proceeds to step 717 to determine whether the signature included in the data is a signature to which an access limitation has been set. Here, the signature to which the access limitation has been set denotes a signature that can be detected by only a specific user, and is intended for solving a problem that a private signature is shared together in the example where the mobile terminal are shared between family members.

When determining that the signature included in the data is not the signature to which the access limitation has been set in step 717, the mobile terminal proceeds to step 721 to reproduce the signature-inserted frame, and then proceeds to step 723 to whether to end the streaming service.

In contrast, when deter mining that the signature included in the data is the signature to which the access limitation has been set in step 717, the mobile terminal proceeds to step 719 to perform an authentication process for signature confirmation. Here, the authentication process for signature confirmation denotes a process of outputting a pop-up window for receiving a predetermined authentication number while reproducing a frame including the signature, and then allowing a receiver to input an authentication number.

At this point, the receiver may be provided with a hit regarding the authentication number or information that can be used as the authentication number from the purchaser or the streaming server. Therefore, a user of the mobile terminal clicks a region including the signature and then performs the authentication process while data are reproduced, thereby preventing signature confirmation by other people.

At this point, the mobile terminal may inform the receiver of existence of the signature to which the access limitation has been set by allowing a position of the signature added by the purchaser to blink using a highlight function. Accordingly, a user to which the access limitation-set signature is not allowed reproduces the streaming contents without understanding contents of the inserted signature.

When failing in the above authentication process, the mobile terminal does not output the signature added by the purchaser but reproduces only streaming data. For example, the mobile terminal outputs a portion including the signature using a box mark and outputs the inserted signature instead of the box mark only if the authentication process is successful.

In contrast, when successful in the authentication process, the mobile terminal outputs the signature added by the purchaser together when outputting the streaming data.

The mobile terminal proceeds to step 723 to determine whether the streaming service ends.

When the streaming service does not end in step 723, the mobile terminal proceeds to step 713 to reproduce the streaming service.

In contrast, when the streaming service ends in step 723, the mobile terminal ends the present algorithm.

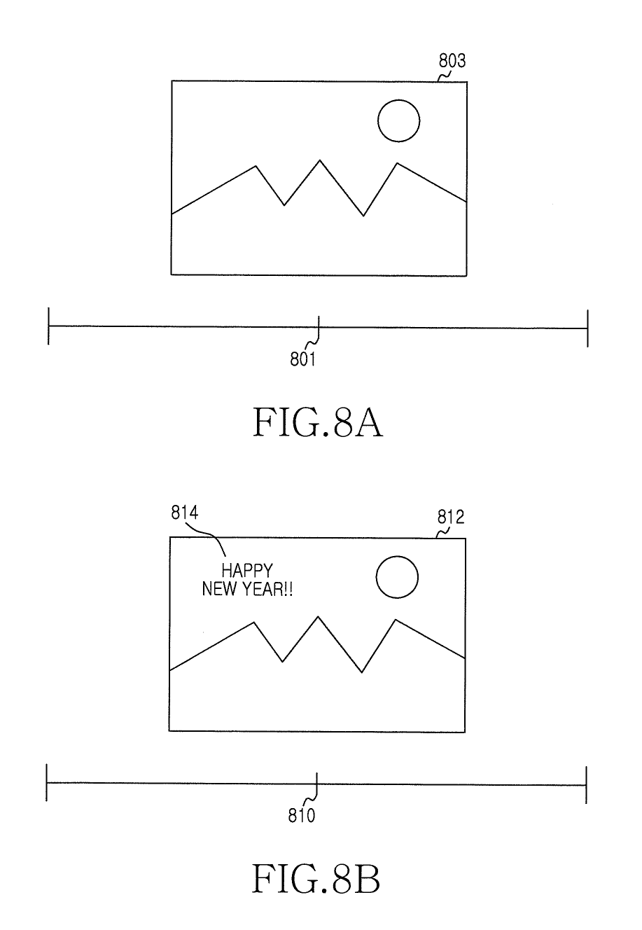

FIGS. 8A and B compare a streaming contents reproducing process of a mobile terminal according to an exemplary embodiment of the present disclosure with that of the conventional mobile terminal.

FIG. 8A illustrates a procedure for reproducing streaming contents in the conventional mobile terminal.

Referring to FIG. 8A, the mobile terminal stores data received from a streaming server in a buffer for a predetermined time, and reproduces the data stored in the buffer.

That is, as illustrated, a reference number 801 represents a reproduction point of the received data, and the mobile terminal outputs data 803 corresponding to the reproduction point.

FIG. 8B illustrates a procedure for reproducing streaming contents in a mobile terminal according to an exemplary embodiment of the present disclosure.

Referring to FIG. 8B, as described above, the mobile terminal stores data received from a streaming server in a buffer for a predetermined time, and reproduces the data stored in the buffer. However, a signature of a purchaser who has purchased streaming contents has been inserted into the data received from the streaming server.

That is, as illustrated, a reference numeral 810 represents a reproduction point of the received data, and the mobile terminal outputs data corresponding to the reproduction point. According to an exemplary embodiment of the present disclosure, the mobile terminal outputs the signature 814 included in the data 812 (greeting message for the New Year may be added to an image where sun rises in the New Year).

When the signature included in the data is a signature to which an access limitation has been set, the mobile terminal does not output the signature but outputs only the data. That is, the mobile terminal does not output the signature when reproducing the data but outputs only signature information (highlight information, and specific figure information) informing signature insertion. Afterward, the mobile terminal outputs the inserted signature together when outputting the data only if an authentication process is successfully performed by a user.

As described above, exemplary embodiments of the present disclosure relate to a digital contents management system for inserting a purchaser's signature to digital contents and providing the same. Exemplary embodiments of the present disclosure allow signature insertion expressing the purchaser's emotion by inserting the purchaser's signature into original contents before generating DRM contents.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A system for digital contents management, the system comprising:
a purchaser terminal configured to detect a user input, write a signature to be inserted into contents, and transmit the written signature to a contents server when purchasing contents;
the contents server configured to insert the signature received from the purchaser terminal into original digital contents; and
a receiver terminal configured to receive and reproduce the original digital contents to which the signature has been added.

2. The system of claim 1, wherein the contents server comprises:
a controller configured to control to insert the signature into the original digital contents;
a contents database (DB) configured to store the original digital contents;
a signature insert unit configured to insert the signature received from the purchaser terminal into the original digital contents;
a Digital Right Management (DRM) contents generator configured to generate the original digital contents to which the signature has been added as DRM contents; and
a communication unit configured to receive the signature from the purchaser terminal and transmit the DRM contents,
wherein the signature insert unit is further configured to determine a signature insertable region of contents which the purchaser terminal desires to purchase and provides the signature insertable region to the purchaser terminal.

3. The system of claim 1, wherein the signature to be inserted into the contents comprises a multimedia file comprising a purchaser's greeting such as a moving image file, an image file, and an audio file as well as a text type signature.

4. The system of claim 1, wherein the purchaser terminal comprises:
a display unit configured to output an item of contents which the purchaser terminal desires to purchase;
an input unit configured to input a signature to be inserted into the contents;
a signature write unit configured to detect a user's input via the input unit and writing the signature;
a communication unit configured to provide the signature written by the signature write unit to the contents server; and
a controller configured to control to insert the signature into the digital contents,
wherein the signature write unit is further configured to output a signature input window to a region selected by a purchaser in a signature insertable region provided from the contents server to receive the purchaser's signature.

5. The system of claim 1, wherein the receiver terminal comprises:
a controller configured to control to reproduce contents received from the contents server;
a contents reproducer configured to release Digital Right Management (DRM) by deciphering a code of the received contents; and
an output unit configured to output the contents whose DRM has been released.

6. The system of claim 5, wherein the output unit comprises at least one of a display unit configured to output visual contents and a speaker for outputting auditory contents.

7. The system of claim 1, wherein one of the purchaser terminal and the contents server is further configured to transmit an authentication number to the receiver terminal to output the signature included in the contents to only a specific user.

8. The system of claim 7, wherein the contents server is further configured to add signature insert information to a region into which the signature has been inserted to inform existence of a signature output to only a specific user.

9. The system of claim 8, wherein the receiver terminal is further configured to perform an authentication process when reproducing contents of a position into which the signature insert information has been added, and output the inserted signature together with reproducing the contents only if the receiver terminal successfully performs the authentication process.

10. The system of claim 1, wherein the purchaser terminal is one of a computer, a mobile communication terminal, and a smart phone.

11. A contents transaction method of a digital contents management system, the method comprising:
detecting, at a purchaser terminal, a user input, writing a signature to be inserted into contents, and transmitting the written signature to a contents server when purchasing the contents;
inserting, at a contents server, the signature received from the purchaser terminal into original digital contents; and
receiving and reproducing, at a receiver terminal, the original digital contents to which the signature has been added.

12. The method of claim 11 further comprising:
storing the original digital contents;
inserting the signature received from the purchaser terminal into the original digital contents;
generating the original digital contents to which the signature has been added as Digital Right Management (DRM) contents; and
transmitting the DRM contents to a receiver, and
wherein inserting the signature received from the purchaser terminal into the original digital contents comprises determining a signature insertable region in contents which the purchaser terminal desires to purchase to provide the signature insertable region to the purchaser terminal.

13. The method of claim 11, wherein the signature to be inserted into the contents comprises a multimedia file comprising a purchaser's greeting such as a moving image file, an image file, and an audio file as well as a text type signature.

14. The method of claim 11 further comprising:
outputting an item of contents which the purchaser terminal desires to purchase;
detecting a user's input to write the signature to be inserted into the contents; and
providing the written signature to the contents server, and
wherein writing the signature comprises outputting a signature input window to a region selected by a purchaser from a signature insertable region provided from the contents server to receive the purchaser's signature.

15. The method of claim 11 further comprising:
releasing Digital Right Management (DRM) by deciphering a code of the received contents; and
outputting the contents whose DRM has been released.

16. The method of claim 14, wherein outputting the contents comprises at least one of outputting visual contents and outputting auditory contents.

17. The method of claim 11 further comprising:
transmitting an authentication number to the receiver terminal to output the contents comprising the signature to only a specific user.

18. The method of claim 17 further comprising:
adding signature insert information to a region into which the signature has been inserted to inform existence of the signature output to only a specific user.

19. The method of claim 18 further comprising:
performing an authentication process when reproducing contents of a position to which the signature insert information has been added; and
outputting the inserted signature together with reproducing the contents only if successfully performing the authentication process.

20. The method of claim 11, wherein the purchaser terminal is one of a computer, a mobile communication terminal, and a smart phone.
